(19) United States
(12) Patent Application Publication
(10) Pub. No.: US 2026/0065421 A1
(43) Pub. Date: Mar. 5, 2026

(54) ELECTRONIC DEVICE AND METHOD FOR ASSISTING APPLICATION DEVELOPMENT

(71) Applicant: MEDIATEK INC., Hsinchu City (TW)

(72) Inventors: Shih-Ting HUANG, Hsinchu City (TW); Kuan-Hung CHOU, Hsinchu City (TW); Chun-I KUO, Hsinchu City (TW); Cheng-Che CHEN, Hsinchu City (TW)

(21) Appl. No.: 19/316,368

(22) Filed: Sep. 2, 2025

Related U.S. Application Data
(60) Provisional application No. 63/690,836, filed on Sep. 5, 2024.

(51) Int. Cl. G06T 3/4053; G06T 1/20; G06T 3/60

(52) U.S. Cl. CPC G06T 3/4053; G06T 1/20; G06T 3/60

(57) ABSTRACT

An embodiment of the present disclosure provides an electronic device. The electronic device includes a memory configured to store a program. The electronic device further includes a central processing unit (CPU) configured to read the program to execute an assistant module and an application. The assistant module is configured to receive a query about an image processing function from the application. The assistant module is further configured to transmit a response message to the application. The response message indicates a processing information for the image processing function executed by a certain hardware component of the electronic device.

### CROSS REFERENCE TO RELATED APPLICATIONS

This application claims priority to U.S. Provisional Application Ser. No. 63/690,836, filed on 2024 Sep. 5, the entirety of which is incorporated by reference herein.

### TECHNICAL FIELD

The present disclosure relates to application development, and, in particular, it relates to an assistant module for image processing function.

### BACKGROUND

Accompanying the popularity of short videos and online streaming, many related applications have been developed. These applications generally provide image processing functions. To achieve the best possible user experience, it is important to ensure that power consumption and performance are optimized while the device is performing these functions of the application. In general, using hardware components to perform this function can use less power than using the central processing unit (CPU) to run the software to perform this function. However, different platforms (e.g. cell phones) have different hardware configurations. Thus, for the same function, some platforms may be able to perform the function with hardware components, while other platforms can't perform the function with hardware components. Because neither the application nor its developers have any way of knowing whether a particular platform can perform a function using hardware components, developers have generally equipped the application to only use the software to perform the function. This leads to higher power consumption.

Thus, a scheme or method is required to solve the aforementioned problem.

### BRIEF SUMMARY

An embodiment of the present disclosure provides an electronic device. The electronic device comprises a memory configured to store a program. The electronic device further comprises a central processing unit (CPU) configured to read the program to execute an assistant module and an application. The assistant module is configured to receive a query about an image processing function from the application. The assistant module is further configured to transmit a response message to the application. The response message indicates a processing information for the image processing function executed by a certain hardware component of the electronic device.

In some embodiments, the processing information indicates whether the image processing function can be executed by the certain hardware component. The certain hardware component is a digital signal processer, an image signal processer, an image resizer, an encoder, or a monitor. In some embodiments, the assistant module is configured to consult a table stored in the memory to determine whether the image processing function can be executed by the certain hardware component of the electronic device.

In some embodiments, the application is configured to use the certain hardware component to execute the image processing function, when the response message indicates that the image processing function can be executed by the certain hardware component of the electronic device. The application is further configured to use the CPU or the GPU to execute the image processing function, when the response message indicates that the image processing function can't be executed by the certain hardware component of the electronic device.

In some embodiments, the assistant module is further configured to receive a setting parameter of the image processing function from the application. The processing information further comprises a quality index. The quality index indicates a result that the certain hardware component executes the image processing function based on the setting parameter. The certain hardware component is a digital signal processer, an image signal processer, an image resizer, an encoder, or a monitor.

In some embodiments, the application is configured to use the certain hardware component of the electronic device other than the CPU and the GPU to execute the image processing function, in response to a determination that the quality index meets a requirement. The application is further configured to either adjust the setting parameter and transmit the adjusted setting parameter to the assistant module again, or use the CPU or the GPU to execute the image processing function, in response to a determination that the quality index doesn't meet the requirement.

In some embodiments, the assistant module is further configured to consult a table stored in the memory to determine the quality index. In some embodiments, the assistant module is further configured to determine the quality index by running a simulation based on the setting parameter.

In some embodiments, the quality index comprises processing time, power consumption, peak signal-to-noise ratio, or a combination thereof. In some embodiments, the image processing function is edge enhancement, resizing the image, rotating the image, super resolution, or transcoding.

An embodiment of the present disclosure provides a method for assisting application development. The method comprises an operation in which a central processing unit (CPU) of an electronic device reads a program stored in a memory of the electronic device to execute an assistant module and an application. The method further comprises an operation in which the assistant module receives a query about an image processing function from the application. The method further comprises an operation in which the assistant module transmits a response message to the application. The response message indicates a processing information for the image processing function executed by a certain hardware component of the electronic device.

### BRIEF DESCRIPTION OF THE DRAWINGS

The present disclosure can be more fully understood by reading the subsequent detailed description and examples with references made to the accompanying drawings, wherein:

FIG. 1 is a block diagram of the electronic device in accordance with embodiments of the present disclosure;

FIG. 2 is a flow diagram of the method for assisting application development in accordance with embodiments of the present disclosure;

FIG. 3 is a flow diagram of the method for assisting application development in accordance with embodiments of the present disclosure; and

FIG. 4 is a flow diagram of the method for assisting application development in accordance with embodiments of the present disclosure.

### DETAILED DESCRIPTION

The following description is made for the purpose of illustrating the general principles of the disclosure and should not be taken in a limiting sense. The scope of the disclosure is best determined by reference to the appended claims.

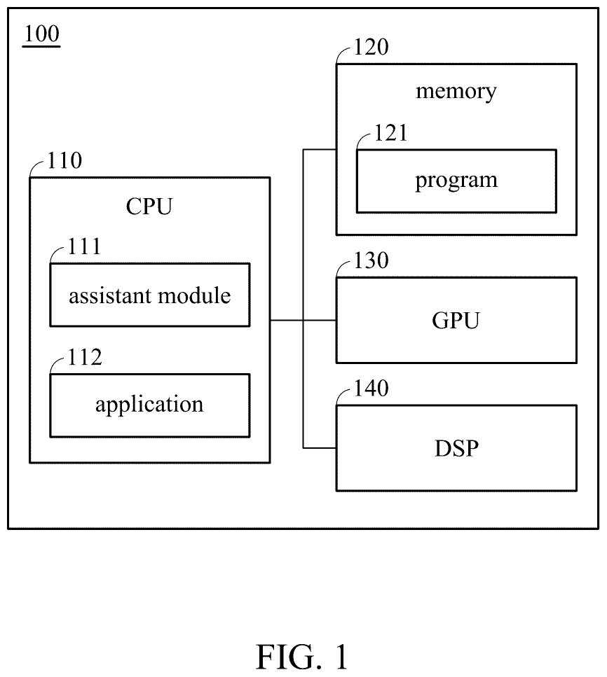

FIG. 1 is a block diagram of the electronic device 100 in accordance with embodiments of the present disclosure. For example, the electronic device 100 may be a mobile device, a wearable device, a wireless communication device, or a computing device. In some embodiments, the electronic device 100 is implemented in a smartphone, a tablet computer, or a notebook computer. The electronic device 100 comprises a central processing unit (CPU) 110, a memory 120, a graphics processing unit (GPU) 130, and an image and media processing unit 140.

The CPU 110 controls operations of the electronic device 100 and provide the required process ability to perform operating systems, programs, software, modules, applications, and functions of the electronic device 100. In some embodiments, the CPU 110 may be implemented in the form of hardware with electronic components including transistors, diodes, capacitors, resistors, or inductors. These components are configured and arranged to perform methods in accordance with the embodiments of the present disclosure. In other words, the CPU 110 is a special-purpose machine specifically configured to perform specific tasks including in accordance with the embodiments of the present disclosure.

The memory 120 stores data and instructions required by the CPU 110. The memory 120 may include non-volatile memories, such as read only memory (ROM) and flash memory. The memory 120 may also include volatile memories, such as dynamic random access memory (DRAM) and static random access memory (SRAM). In some embodiments, the memory 120 stores a program 121, such as the computer-readable instruction. The program 121 can be read by the CPU 110. When the program 121 is read and executed by the CPU 110, the program 121 causes the CPU 110 to execute (or implement) an assistant module 111 and an application 112 and to perform methods in accordance with the embodiments of the present disclosure. The assistant module 111 and the application 112 are software modules.

In some embodiments, the application 112 has image processing functions. For example, the image processing function may be edge enhancement, resizing the image, rotating the image, super resolution, or transcoding. The edge enhancement function is configured to increase the clarity or quality of the image or video. The function of resizing the image is configured to adjust the size of the image. The super resolution function is configured to enhance details of the image or video or increase the resolution of image or video. The transcoding function is configured to transcode the image or video or increase transcoding speed. The electronic device 100 may use the software or hardware to execute (or implement) the image processing functions. Using the software to implement the image processing function may referred to that the electronic device 100 use the CPU 110 or the GPU 130 to execute the software and thereby implement the image processing function. Using the hardware to implement the image processing function may referred to that the electronic device 100 use certain hardware component of the electronic device 100 execute the image processing function. These hardware components may or may not cooperate with the CPU 110 or the GPU 130 to implement the image processing function. In some embodiments, the certain hardware component (i.e. the hardware component of the electronic device 100 other than the CPU 110 or the GPU 130) which is used to execute the image processing function doesn't perform instructions from the CPU 110. In some embodiments, the hardware component is configured to perform fixed operations. Specifically, the hardware component may first be in the sleep mode or idle mode. Then, the hardware component is waked-up to receive the task. Because the hardware component performs fixed operations, the hardware component processes the task without instruction from the CPU 110. After the hardware component completes the task, the hardware component returns the result and enters the sleep mode or idle mode again. For example, the hardware component is the image and media processing unit 140, the encoder, or the monitor. In some embodiments, the image and media processing unit includes a Digital Signal Processer, an Image Signal Processer, and an Image Resizer.

In general, using the certain hardware components to perform the image processing function can achieve lower power consumption than using the CPU 110 or GPU 130 to run the software to implement the function. However, different platform (e.g. cell phone) has different hardware configuration. Thus, the application 112 or the developer of the application 112 cannot be sure whether an image processing function is able to be implemented using a certain hardware component and the performance of the certain hardware component. The assistant module 111 in accordance with embodiments of the present disclosure allows the application 112 or the developer to know whether an image processing function is able to be implemented using the certain hardware component. Furthermore, the assistant module 111 allows the application 112 or the developer to know the result of image processing function performed by the certain hardware component. Thus, the application 112 can determine how to perform the image processing function.

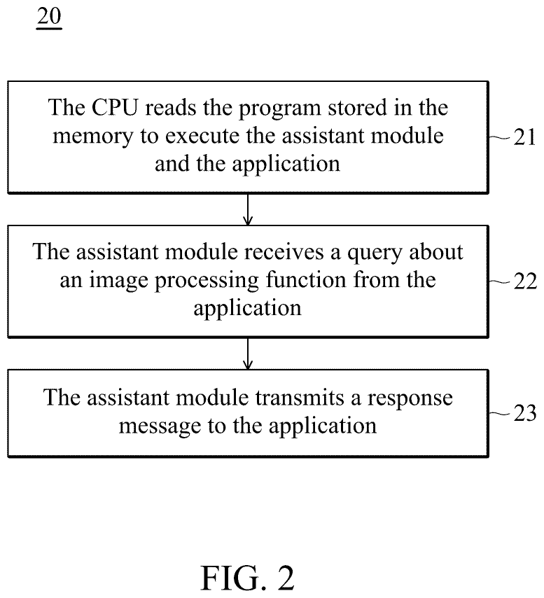

FIG. 2 is a flow diagram of the method 20 for assisting application development in accordance with embodiments of the present disclosure. In operation 21, the CPU 110 reads the program 121 stored in the memory 120 to execute the assistant module 111 and the application 112. In operation 22, the assistant module 111 receives a query about an image processing function from the application 112. The query indicates an image processing function of the application 112. For example, the query is a message which includes the name of the image processing function or an identifier indicating the image processing function. In operation 23, the assistant module 111 transmits a response message to the application 112. The response message indicates a processing information for the image processing function (i.e. the image processing function indicated by the query) executed by a certain hardware component of the electronic device 100. In other words, the processing information is the processing information for the image processing function related to the certain hardware component. For example, the processing information may indicate whether the image processing function can be executed by the certain hardware information, and/or the result that the certain hardware component executes the image processing function. In some embodiments, the certain hardware component may be a digital signal processer, an image signal processer, an image resizer, an encoder, or a monitor. In some embodiments, the certain hardware component may be different with the CPU 110 and the GPU 130 and may cooperate with the CPU 110 and the GPU 130 to implement the image processing function.

In some embodiments, assistant module 111 consults (looks up) a table stored in the memory 120 to determine whether the image processing function can be executed by the certain hardware component. The memory 120 stores the information about whether each of the image processing functions can be executed by the certain hardware components in the form of the table. For example, the rows of the table represent the image processing function, and the columns of the table represent an indicator indicating whether the image processing function corresponds to the indicator can be executed by the certain hardware components. In some embodiments, the table may further record which hardware components are capable of executing the image processing function. For example, the rows of the table represent the image processing function, and the columns of the table represent hardware components capable of executing the corresponding image processing function. In the different electronic devices, the table may be different. In some embodiments, the developer of the assistant module 111 collects the data for different electronic devices (e.g. via experiment) in order to build the table.

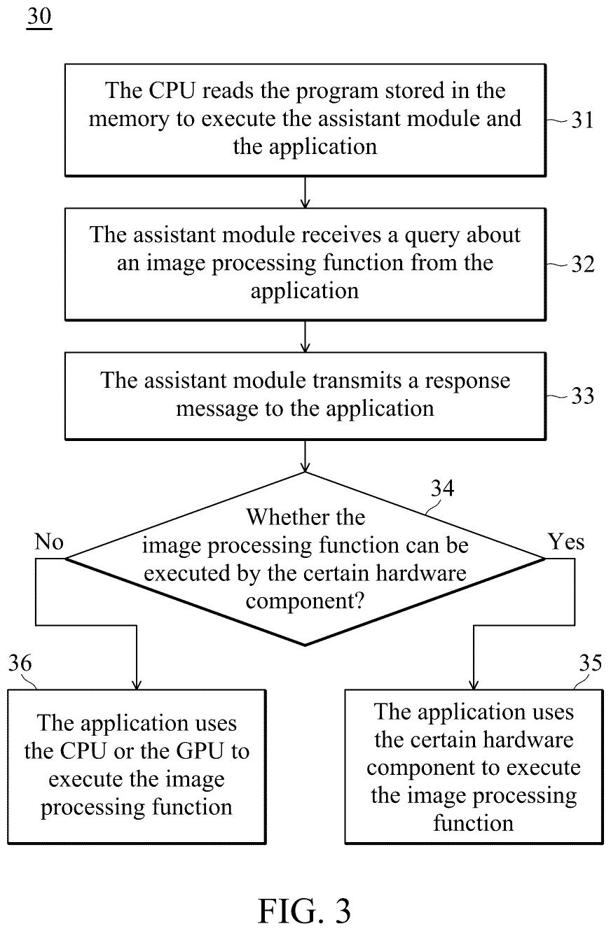

FIG. 3 is a flow diagram of the method 30 for assisting application development in accordance with embodiments of the present disclosure. In operation 31, the CPU 110 reads the program 121 stored in the memory 120 to execute the assistant module 111 and the application 112. In operation 32, the assistant module 111 receives a query about an image processing function from the application 112. In operation 33, the assistant module 111 transmits a response message to the application 112. The response message indicates a processing information for the image processing function executed by a certain hardware component of the electronic device. Operations 31˜33 may be similar to operations 21˜23.

In operation 34, the application 112 determines whether the image processing function can be executed by the certain hardware component of the electronic device 100, based on the processing information. When the processing information indicates that the image processing function can be executed by the certain hardware component, the application 112 performs operation 35. When the processing information indicates that the image processing function can't be executed by the hardware component, the application 112 performs operation 36. In operation 35, the application 112 uses the certain hardware component (such as the image and media processing unit 140, the encoder, or the monitor) to execute the image processing function. In operation 36, the application 112 uses the CPU or the GPU (to perform the software program, such as the program 121) to execute the image processing function.

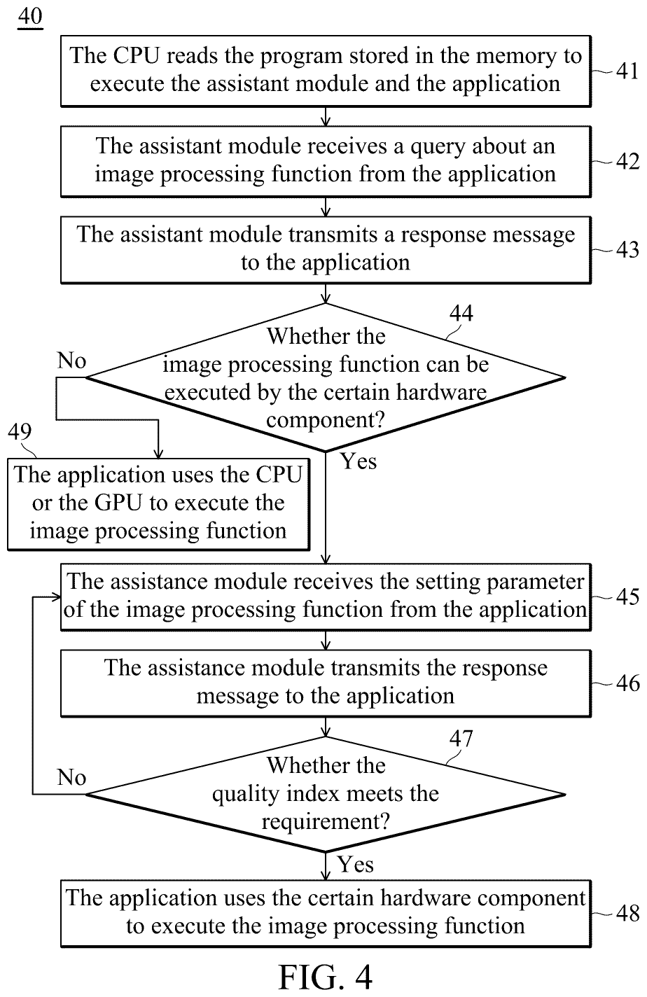

FIG. 4 is a flow diagram of the method 40 for assisting application development in accordance with embodiments of the present disclosure. In operation 41, the CPU 110 reads the program 121 stored in the memory 120 to execute the assistant module 111 and the application 112. In operation 42, the assistant module 111 receives a query about an image processing function from the application 112. In operation 43, the assistant module 111 transmits a response message to the application 112. The response message indicates a processing information for the image processing function executed by a certain hardware component of the electronic device. Operations 41˜43 may be similar to operations 21˜23. In operation 44, the application 112 determines whether the image processing function can be executed by the certain hardware component, based on the response message. When the processing information indicates that the image processing function can be executed by the certain hardware component, the application 112 performs operation 45. When the processing information indicates that the image processing function can't be executed by the certain hardware component, the application 112 performs operation 49. In operation 49, the application 112 uses the CPU or the GPU (to perform the software program, such as the program 121) to execute the image processing function.

In operation 45, the assistant module 111 receives the setting parameter(s) of the image processing function (i.e. the image processing function indicated by the query) from the application 112. Setting parameter is the parameter required by the certain hardware component to execute the image processing function. For example, when the image processing function is resizing the image, the setting parameter may be the original size and the target size, such as 720P and 1080P. When the image processing function is edge enhancement, the setting parameter may be the target degree of sharpness.

In operation 46, the assistant module 111 transmits the response message to the application 112. In the response message, the processing information comprises quality index(es). The quality index indicates the result that the certain hardware component executes the image processing function based on the setting parameter. In some embodiments, the quality index comprises the processing time, the power consumption, the peak signal-to-noise ratio (PSNR), or a combination thereof. Specifically, the processing time is the time duration consumed by the certain hardware component to finish the image processing function based on the setting parameter. The power consumption is the power consumed by the certain hardware component to execute the image processing function based on the setting parameter. The PSNR is the PSNR of the image generated by the certain hardware component via executing the image processing function based on the setting parameter. It should be noted that, in operation 46, the certain hardware component hasn't execute the image processing function. The quality index transmitted from the assistant module 111 is the quality index estimated by the assistant module 111. For example, when the image processing function is resizing the image and the setting parameters are 720P and 1080P, the quality index may be the resulted processing time and power consumption that the certain hardware component transforms the 720P image into a 1080P image. When the image processing function is edge enhancement and the setting parameter is the target degree of sharpness, the quality index may be the resulted processing time, power consumption, and PSNR that the certain hardware component transforms the image into the target degree of sharpness.

In some embodiments, the assistant module consults (looks up) a table stored in the memory 120 to determine the quality index. The table records quality indexes, and each of the quality index corresponds to an image processing function and a setting parameter (or a set of setting parameters). For example, table 1 shows a part of the table stored in the memory 120.

TABLE 1

| Image processing | Processing | | Power | | |
|---|---|---|---|---|---|
| function | time | | consumption | | PSNR |
| edge enhancement | 30 | ms | 5 | mA | 45 dB |
| resizing the image | 30 | ms | 5 | mA | NA |
| rotating the image | 30 | ms | 5 | mA | NA |
| super resolution | 500 | ms | 100 | mA | 30 dB |
| transcoding | 5 | s | 50 | mA | 20 dB |

In the different electronic device, the table may be different. In some embodiments, the developer of the assistant module 111 collects the data for different electronic devices (e.g. via the experiment) in order to build the table.

In other embodiments, the assistant module 111 determines the quality index by running a simulation based on the setting parameter. The assistant module 111 may determine the quality index using the simulation or the algorithm based on the setting parameter. In some embodiments, before determining the quality index, the assistant module 111 further activates the certain hardware component.

In operation 47, the application 112 determines whether the quality index meets the requirement. In some embodiments, the application 112 compares the quality index with the threshold to determine whether the quality index meets the requirement. When the quality index meets the requirement (e.g. the quality index is higher than or lower than the threshold), the application performs operation 48. In operation 48, the application 112 uses the certain hardware component to execute the image processing function. When the quality index doesn't meet the requirement, the operation 45 is performed again. In other words, the application may adjust the setting parameter to different value and transmit the adjusted setting parameter to the assistant module again. In other embodiments, when the quality index doesn't meet the requirement, the application performs operation 49.

Embodiments of the present disclosure allows the application or the developer to know whether an image processing function is able to be implemented using a certain hardware component and the result of the certain hardware component executing the image processing function. The application can use the certain hardware component to perform the image processing function whenever it is possible. Thus, the power consumption and the performance are thereby improved, and a better user experience can be achieved.

While the disclosure has been described by way of example and in terms of the preferred embodiments, it should be understood that the disclosure is not limited to the disclosed embodiments. On the contrary, it is intended to cover various modifications and similar arrangements. Therefore, the scope of the appended claims should be accorded the broadest interpretation so as to encompass all such modifications and similar arrangements.

What is claimed is:

1. An electronic device, comprising:
a memory, configured to store a program;
a central processing unit (CPU), configured to read the program to execute an assistant module and an application;
wherein the assistant module is configured to:
receive a query about an image processing function from the application; and
transmit a response message to the application, wherein the response message indicates a processing information for the image processing function executed by a certain hardware component of the electronic device.

2. The electronic device as claimed in claim 1, wherein the processing information indicates whether the image processing function can be executed by the certain hardware component, wherein the certain hardware component is a digital signal processer, an image signal processer, an image resizer, an encoder, or a monitor.

3. The device as claimed in claim 2, wherein the assistant module is configured to consult a table stored in the memory to determine whether the image processing function can be executed by the certain hardware component.

4. The electronic device as claimed in claim 2, wherein the application is configured to:
use the certain hardware component to execute the image processing function, when the processing information indicates that the image processing function can be executed by the certain hardware component; and
use the CPU or the GPU to execute the image processing function, when the response message indicates that the image processing function can't be executed by the certain hardware component.

5. The electronic device as claimed in claim 1, wherein the assistant module is further configured to:
receive a setting parameter of the image processing function from the application;
wherein the processing information further comprises a quality index, wherein the quality index indicates a result that the certain hardware component executes the image processing function based on the setting parameter, wherein the certain hardware component is a digital signal processer, an image signal processer, an image resizer, an encoder, or a monitor.

6. The electronic device as claimed in claim 5, wherein the application is configured to:
use the certain hardware component to execute the image processing function, in response to a determination that the quality index meets a requirement; and
adjust the setting parameter and transmit the adjusted setting parameter to the assistant module again, or use the CPU or the GPU to execute the image processing function, in response to a determination that the quality index doesn't meet the requirement.

7. The electronic device as claimed in claim 5, wherein the assistant module is further configured to:
consult a table stored in the memory to determine the quality index.

8. The electronic device as claimed in claim 5, wherein the assistant module is further configured to:
determine the quality index by running a simulation based on the setting parameter.

9. The electronic device as claimed in claim 5, wherein the quality index comprises processing time, power consumption, peak signal-to-noise ratio, or a combination thereof.

10. The electronic device as claimed in claim 1, wherein the image processing function is edge enhancement, resizing the image, rotating the image, super resolution, or transcoding.

11. A method for assisting application development, comprising:
reading, via a central processing unit (CPU) of an electronic device, a program stored in a memory of the electronic device to execute an assistant module and an application;
receiving, via the assistant module, a query about an image processing function from the application; and
transmitting, via the assistant module, a response message to the application, wherein the response message indicates a processing information for the image processing function executed by a certain hardware component of the electronic device.

12. The method as claimed in claim 11, wherein the processing information indicates whether the image processing function can be executed by certain hardware component, wherein the certain hardware component is a digital signal processer, an image signal processer, an image resizer, an encoder, or a monitor.

13. The method as claimed in claim 12, further comprising:
consulting, via the assistant module, a table stored in the memory to determine whether the image processing function can be executed by the certain hardware component.

14. The method as claimed in claim 12, further comprising:
using, via the application, the certain hardware component to execute the image processing function, when the response message indicates that the image processing function can be executed by the hardware component; and
using, via the application, the CPU or the GPU to execute the image processing function, when the response message indicates that the image processing function can't be executed by the hardware component.

15. The method as claimed in claim 11, further comprising:
receiving, via the assistant module, a setting parameter of the image processing function from the application;
wherein the processing information further comprises a quality index, wherein the quality index indicates a result that the certain hardware component executes the image processing function based on the setting parameter, wherein the certain hardware component is a digital signal processer, an image signal processer, an image resizer, an encoder, or a monitor.

16. The method as claimed in claim 15, further comprising:
using, via the application, the certain hardware component to execute the image processing function, in response to a determination that the quality index meets a requirement; and
adjusting, via the application, the setting parameter and transmitting the adjusted setting parameter to the assistant module again, or using the CPU or the GPU to execute the image processing function, in response to a determination that the quality index doesn't meet the requirement.

17. The method as claimed in claim 15, further comprising:
consulting, via the assistant module, a table stored in the memory to determine the quality index.

18. The method as claimed in claim 15, further comprising:
determining, via the assistant module, the quality index by running a simulation based on the setting parameter.

19. The method as claimed in claim 15, wherein the quality index comprises processing time, power consumption, peak signal-to-noise ratio, or a combination thereof.

20. The method as claimed in claim 11, wherein the image processing function is edge enhancement, resizing the image, rotating the image, super resolution, or transcoding.
